(19) United States
(12) Patent Application Publication
(10) Pub. No.: US 2006/0277002 A1
(43) Pub. Date: Dec. 7, 2006

(54) system and method for analysis of measurement data

(76) Inventors: Per Kangru, Fredriksberg (DK); Scott A. Blomquist, Colorado Springs, CO (US)

Correspondence Address: AGILENT TECHNOLOGIES INC., INTELLECTUAL PROPERTY ADMINISTRATION, M/S DU404, P.O. BOX 7599, LOVELAND, CO, 80537-0599, US

(21) Appl. No.: 11/142,728

(22) Filed: Jun. 1, 2005

(51) Int. Cl. G06F 15/00

(52) U.S. Cl. 702/190

(57) ABSTRACT

A system and method for providing an electronic resort and presentation of measurements, such as calls in a telephone network. The system and method allow the selection of measurement attributes and measurement attribute values in which to view statistical graphs, provide the statistical graphs, and allow the selection of a part of one of the statistical graphs, for example a bar in a bar graph, to filter the measurements, such as calls, by that measurement attribute, such as establish cause and measurement attribute value, such as terminating conversational call. The system and method can further allow the filtering of measurements by the selected measurement attribute and selected measurement attribute value, the displaying of a new statistical graph, and the selection of a part of the new statistical graph. These steps could be repeated until selection is made to display the actual measurements from which the statistics have been gathered.

### BACKGROUND OF THE INVENTION

Electronically recorded measurements, such as information about calls in a telephone network, can provide useful information for many purposes. One such purpose could be trouble-shooting. Other purposes can include, in the case of the telephone network, load balancing, load monitoring, and call typing. When there are many measurements arriving at a high rate, an electronic system is sometimes used to analyze them and provide them to an operator, for example, so that they can provide timely information about the situation from which the measurements emanate. Current electronic systems allow users to organize measurements according to measurement attributes and graph them. Continuing with the telephone network example, measurement attributes can include establishment cause, release cause, and service type. Each call can be tagged with any or all of these attributes, each attribute of which can take any number of values. Graphically, the measurements can be represented in bar graph form where each bar can represent the number of calls having a particular attribute value. Each attribute is thus represented by a separate bar in the distribution graph.

Current systems allow the selection of a bar of the bar graph that can provide a list of the measurements having the particular attribute value. However, what is needed is an electronic resort and presentation of those same measurements according to another attribute. Such a system could provide filtering of measurements from a statistical graph, and thus could reduce the manual analysis involved in sorting measurements. Such a system could be used to electronically narrow searches for any type of data, including electronic search results.

### SUMMARY OF THE INVENTION

The problems set forth above as well as further and other problems are resolved by the present invention. The solutions and advantages of the present invention are achieved by the illustrative embodiments and methods described herein below.

The system and method of the present invention provide an electronic resort and presentation of data, such as call data (referred to herein as measurements) through statistical analysis and graphical display. The method of the present invention can include, but is not limited to, the steps of allowing selection of measurement attributes, such as call attributes, in which to view statistical graphs, such as distribution graphs, providing the statistical graphs, and allowing selecting of a part of one of the statistical graphs, for example a bar in a bar graph, to filter the measurements by that attribute. The method can further include the steps of filtering the measurements by the selected attribute, displaying a new statistical graph, and allowing selection of a part of the new statistical graph. These steps could be repeated until selection is made to display the actual measurements from which the statistics have been gathered, a process known as drilling down.

The system of the present invention can include, but is not limited to, a measurement interface capable of receiving measurements, an attribute manager capable of receiving a selection of a measurement attribute and organizing the measurements according to the measurement attribute, a measurement analyzer capable of computing statistics of the measurements with respect to the measurement attribute, and a display processor capable of displaying the statistics in the form of a statistical graph. The display processor can also display the measurements associated with the statistical graph. The system of the present invention can optionally include a user interface capable of receiving user input and directing the display processor to display the statistics or the measurements, where the user interface can receive a measurement attribute and directing the attribute manager to store the measurement attribute. The system of the present invention can also optionally include a resorter capable of filtering measurements with respect to the measurement attribute. The display processor can optionally include a measurement list creator capable of displaying measurements according to user input, and a statistics graph creator capable of forming the statistics into a statistics graph based on user input.

For a better understanding of the present invention, reference is made to the accompanying drawings and detailed description. The scope of the present invention is pointed out in the appended claims.

### DESCRIPTION OF THE SEVERAL VIEWS OF THE DRAWING

FIG. 1 is a schematic block diagram of the environment in which the system and method of the present invention execute;

FIG. 2 is a schematic block diagram depicting the components of the system of the present invention;

FIG. 3 is a flowchart of the method of the present invention;

FIG. 4 is an illustrative list of calls and call attribute values organized by call attribute; and

FIGS. 5A, 5B, and 5C are illustrative call attribute value distribution graphs that illustrate the calls and call attributes of FIG. 4.

### DETAILED DESCRIPTION OF THE INVENTION

The present invention is now described more fully hereinafter with reference to the accompanying views of the drawing, in which the illustrative embodiments of the present invention are shown.

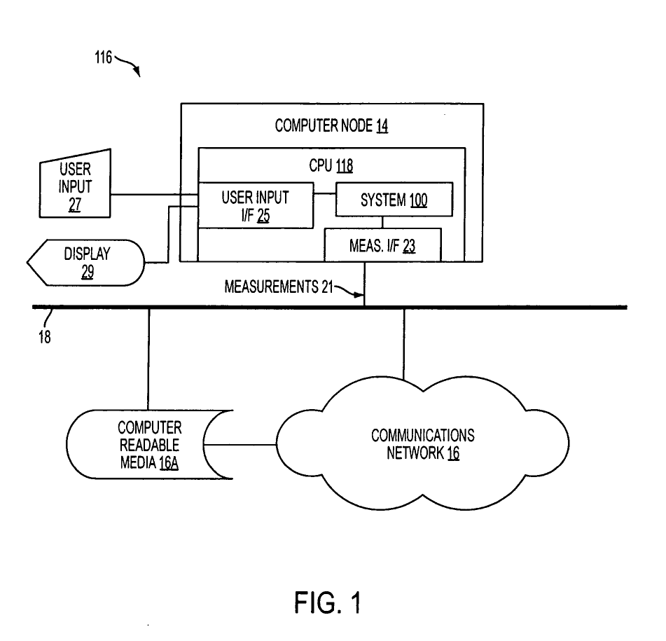

Referring now to FIG. 1, environment 116 in which system 100 executes can include, but is not limited to, Central Processing Unit (CPU) 118, user input 27, user input interface 25, measurement interface 23, and display 29. CPU 118 is typically in the form of a general data processor, such as those commonly found in personal computing devices, but may also be a specialized computing processor designed for a more specific task. Additionally, system 100 may be downloaded from communications network 16 or from at least one computer readable medium 16A through electronic interface 18. Common forms of at least one computer-readable medium 16A can include, for example, but are not limited to, a floppy disk, a flexible disk, a hard disk, magnetic tape, or any other magnetic medium, a CDROM or any other optical medium, punched cards, paper tape, or any other physical medium with patterns of holes, a RAM, a PROM, and EPROM, a FLASH-EPROM, or any other memory chip or cartridge, a carrier wave, or any other medium from which a computer can read. Signals representing actions taken by elements of system 100 can travel over communications network 16. Control and data information can be electronically executed and stored on computer-readable medium 16A. System 100 can be implemented to execute on computer node 14 in communications network 16.

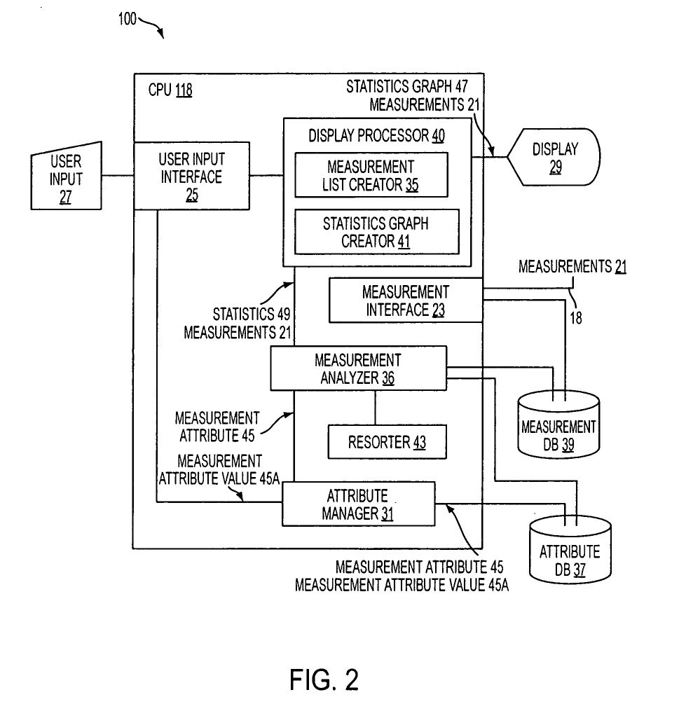

Referring now primarily to FIG. 2, system 100 of the present invention for providing measurements 21 according to selected measurement attributes 45 can include, but is not limited to, user input interface 25, display processor 40, measurement interface 23, measurement analyzer 36, resorter 43, and attribute manager 31. Measurement interface 23 can receive measurements 21 from, for example, electronic interface 18, which can be electronically connected to any type of measuring device, or which can receive measurements 21 from communications network 16 (FIG. 1), or from computer readable media 16A (FIG. 1), for example. Attribute manager 31 can receive a selection of at least one measurement attribute 45, from, for example, user input 27 through user input interface 25, and can organize measurements 21 according to the selected measurement attributes 45. Attribute manager 31 can store at least one measurement attribute 45 in attribute database 37, or can provide the selected measurement attributes 45 to measurement analyzer 36 directly. Measurement analyzer 36 can compute statistics 49 of measurements 21 with respect to at least one measurement attribute 45, which measurement analyzer 36 can retrieve from attribute database 37 according to information provided by attribute manager 31. Both measurement analyzer 36 and measurement interface 23 can store measurements 21 in measurement database 39. Display processor 40 can display statistics 49 to, for example, display 29, in the form of one or more statistical graphs 47, and can also display measurements 21 associated with the one or more statistical graphs 47, according to, for example, but not limited to, requests received through user input interface 25 from user input 27. For example, if one or more statistical graphs 47 is a bar graph, and user input 27 is a single click on a distribution bar in the bar graph, display processor 40 can adjust other bar graphs to be filtered by the at least one measurement attribute value 45A associated with the single click. As a further example, if user input 27 is a double click on a distribution bar in the bar graph, display processor 40 can provide the measurements 21 that are associated with the distribution bar that is associated with the selected measurement attribute value 45A. To accommodate multiple types of information (statistics 49 and measurements 21), display processor 40 can include, but is not limited to, measurement list creator 35 capable of displaying measurements 21 according to user input 27, and statistics graph creator 41 capable of forming statistics 49 into one or more statistical graphs 47 based on user input 27.

Continuing to refer to FIG. 2, system 100 can optionally include a user input interface 25 that can receive user input 27 and direct display processor 40 to display statistics 49 or measurements 21. User input interface 25 can also receive at least one measurement attribute value 45A selection and direct attribute manager 31 to store the at least one measurement attribute value 45A. System 100 can further optionally include resorter 43 capable of filtering measurements 21 with respect to at least one measurement attribute value 45A. Measurement attribute values 45A can be, for example, values that measurement attributes can take to further refine filtering, for example, establish clause =TCC, OBC, or REG.

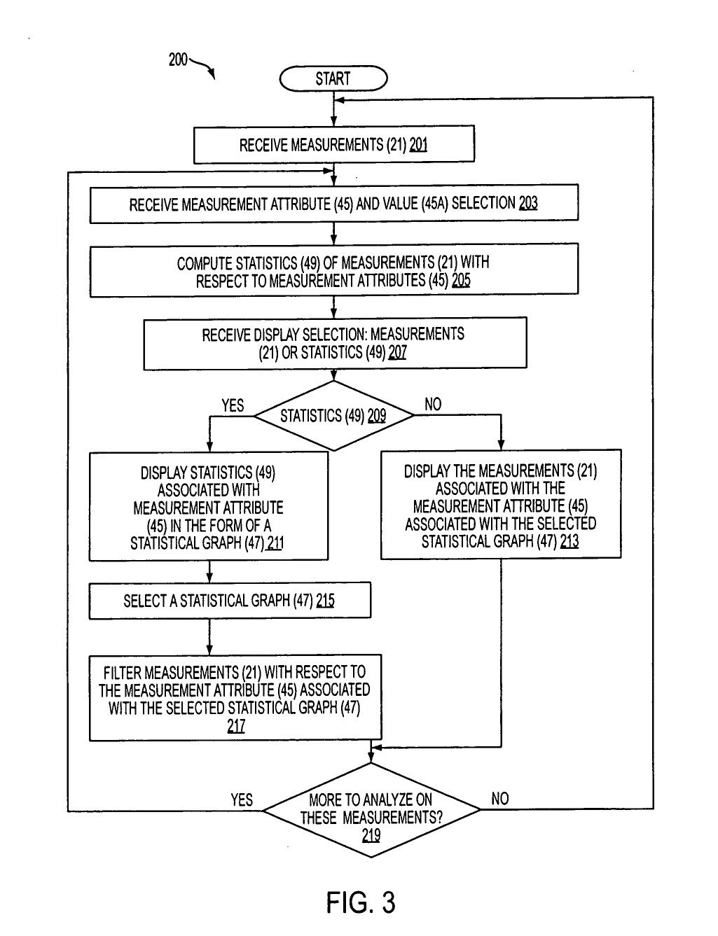

Referring now primarily to FIG. 3, method 200 for providing measurements 21 (FIG. 2) according to selected measurement attribute values 45A (FIG. 2) can include, but is not limited to, the steps of receiving measurements 21 (method step 201) and receiving at least one measurement attribute value 45 (FIG. 2) selection (method step 203). Method 200 can also include the steps of computing statistics 49 of measurements 21 with respect to at least one measurement attribute 45 (method step 205) and receiving display selection—either measurement 21 or statistics 49 (method step 207). If the user, for example, chooses to display statistics 49 (decision step 209), method 200 can include the steps of displaying statistics 49 associated with at least one measurement attribute 45 in the form of one or more statistical graphs 47 (method step 211), allowing the selection of one or more statistical graphs 47 (method step 215), and filtering measurements 21 with respect to the at least one measurement attribute value 45A associated with the selected at least one statistical graph (method step 217). If the user, for example, chooses to display measurements 21 (decision step 209), method 200 can include the step of displaying measurements 21 associated with at least one measurement attribute value 45A that is associated with the selected at least one statistical graph (method step 213). If the user, for example, desires to continue sorting measurements 21 (decision step 219), method 200 can continue processing at method step 203. If the user, for example, desires to process new or different measurements 21 (decision step 219), method 200 can continue processing at method step 201.

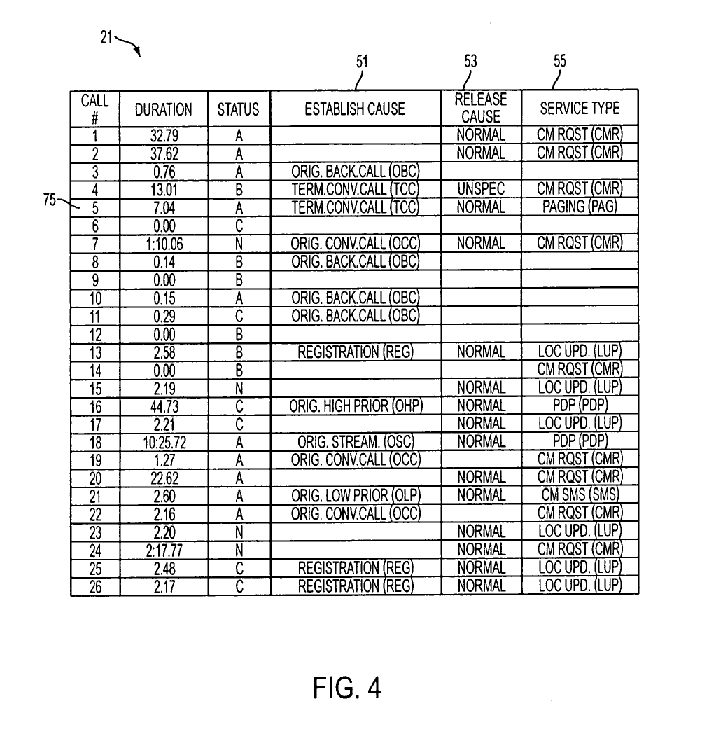

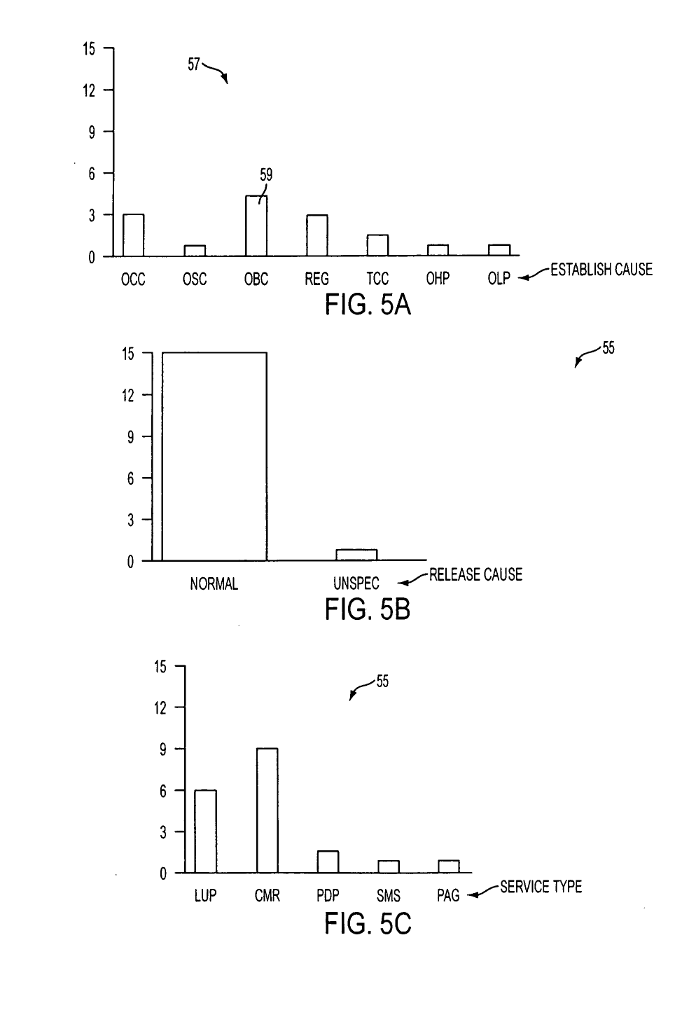

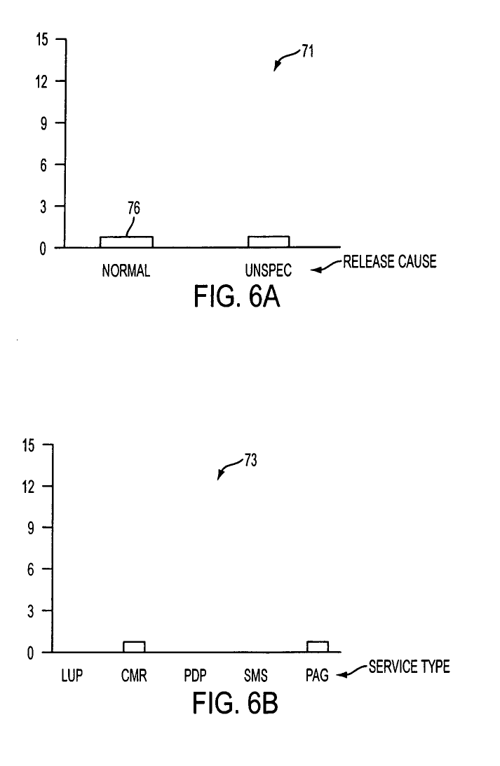

Referring now primarily to FIGS. 4, 5A-5C, and 6A-6B, illustrative measurements 21 (FIG. 2) are shown (FIG. 4), and associated illustrative statistical analyses are presented in bar graph form (FIGS. 5A-5C). In the illustrative embodiment, a user, for example, chooses to compute statistics 49 (FIG. 2) such as, for example, the number of calls having a particular measurement attribute value 45A (FIG. 2), on measurements 21, having measurement attributes 45 (FIG. 2) such as establish cause attribute 51 (FIG. 4), release cause attribute 53 (FIG. 4), and call service type attribute 55 (FIG. 4). In FIG. 5A, establish cause graph 57 (FIG. 5A) represents the number of calls having particular values of establish cause attribute 51. For example, two calls have the establish cause of terminating conversational call (TCC). If a user selects (by single click on OBC bar 59 (FIG. 5A), for example) measurement attribute value 45A establish cause TCC, system 100 (FIG. 2) can resort measurements 21 according to establish cause value TCC and can display statistics 49 represented in FIGS. 5B and 5C as are shown in FIGS. 6A and 6B in which statistics about the TCC calls are shown in TCC filtered release cause graph 71 (FIG. 6A) and filtered TCC service type graph 73 (FIG. 6B). Optionally a single click could allow a user to filter based on several measurement attributes values 45A (FIG. 2). A further selection of, for example, normal bar 76 (FIG. 6A), by, for example, a double click, could drill down and display the actual measurement 21 of call #5, line 75 (FIG. 4).

Although the invention has been described with respect to various embodiments and methods, it should be realized that this invention is also capable of a wide variety of further and other embodiments and methods within the spirit and scope of the appended claims.

1. A method for providing measurements according to at least one measurement attribute value comprising the steps of:
selecting at least one measurement attribute;
computing statistics of measurements with respect to the at least one measurement attribute value associated with the selected at least one measurement attribute;
presenting a display having the statistics associated with the at least one measurement attribute value in the form of at least one statistical graph;
selecting at least a portion of the at least one statistical graph from the display;
computing statistics of the measurements with respect to the at least one measurement attribute value associated with the selected at least one statistical graph; and
presenting another display having the result of said step of computing statistics of the measurements with respect to the at least one measurement attribute value associated with the selected at least one statistical graph.

2. The method of claim 1 wherein the at least one statistical graph is a bar graph.

3. The method of claim 1 wherein the at least one statistical graph is a pie chart.

4. The method of claim 1 wherein the measurements include call information.

5. The method of claim 1 wherein the statistics include the number of the measurements that have a value equal to the at least one measurement attribute value.

6. A system for providing analyzed measurements comprising:
a measurement interface capable of receiving measurements;
an attribute manager capable of receiving a selection of at least one measurement attribute and organizing said measurements related to said at least one measurement attribute according to an order of said at least one measurement attribute;
a measurement analyzer capable of computing statistics of said measurements with respect to said at least one measurement attribute; and
a display processor capable of providing said statistics in the form of at least one statistical graph, said display processor capable of providing said measurements associated with said at least one statistical graph.

7. The system of claim 6 further comprising:
a user input interface capable of receiving user input and directing said display processor to display said statistics or said measurements, said user interface capable of receiving said at least one measurement attribute and directing said attribute manager to store said at least one measurement attribute.

8. The system of claim 6 further comprising:
a resorter capable of filtering measurements with respect to at least one measurement attribute value associated with said at least one measurement attribute.

9. The system of claim 6 wherein said display processor further comprises:
a measurement list creator capable of displaying measurements according to user input; and
a statistics graph creator capable of forming said statistics into said at least one statistical graph based on user input.

10. The system of claim 6 wherein said at least one statistical graph is a bar graph.

11. The system of claim 6 wherein said at least one statistical graph is a pie chart.

12. A system for displaying related attribute value statistics comprising:
(a) means for selecting a first measurement attribute having a set of first attribute values;
(b) means for selecting a second measurement attribute having a set of second attribute values related to the set of first attribute values,
(c) means for computing related attribute value statistics of the second measurement attribute values across the set of first attribute values,
(d) means for displaying the related attribute value statistics in the form of at least one graph,
(e) means for selecting at least a portion of the at least one graph;
(f) means for setting values from the portion of the at least one graph as the set of first attribute values; and
(g) repeating means (b) through (f) while means (e) is executed.

13. The system of claim 12 wherein said at least one statistical graph is a bar graph.

14. The system of claim 12 wherein said at least one statistical graph is a pie chart.

15. The system of claim 12 wherein said measurements include call information.

16. The system of claim 12 wherein said statistics include the number of said measurements that have a value equal to said at least one measurement attribute.

17. A computer node for carrying out the method according to claim 1.

18. A communications network comprising a computer node according to the method of claim 1.

19. The method of claim 1 wherein said method steps are performed by a computer that receives a carrier wave from a computer network, the carrier wave carrying information for executing said method steps.

20. A computer readable medium having instructions embodied therein for the practice of the method of claim 1.

21. A system for providing calls associated with at least one call attribute value comprising:
means for selecting at least one call attribute, said at least one call attribute being associated with the at least one call attribute value;
means for computing statistics of calls with respect to the at least one call attribute value;
means for providing said statistics of calls in the form of at least one distribution graph;
means for selecting at least a portion of said at least one distribution graph;
means for computing statistics from said calls with respect to the at least one call attribute value associated with the selected at least one distribution graph;
means for drilling down to provide information associated with the calls according to the at least one call attribute value; and
means for displaying the information.

22. The system of claim 21 wherein said at least one distribution graph is a bar graph.

23. The system of claim 21 wherein said at least one distribution graph is a pie chart.

24. The system of claim 21 wherein said statistics include the number of the calls that have said at least one call attribute.
